(19) United States
(12) Patent Application Publication
(10) Pub. No.: US 2022/0338484 A1
(43) Pub. Date: Oct. 27, 2022

(54) SYSTEM AND METHOD FOR PREPARING AN EDIBLE BUN

(71) Applicant: Jay Welford, West Bloomfield, MI (US)

(72) Inventor: Jay Welford, West Bloomfield, MI (US)

(21) Appl. No.: 17/719,839

(22) Filed: Apr. 13, 2022

Related U.S. Application Data
(60) Provisional application No. 63/178,135, filed on Apr. 22, 2021.

(51) Int. Cl. A21B 3/13; A21D 8/06; A21D 8/08; A21D 13/10

(52) U.S. Cl. CPC A21B 3/132; A21D 8/06; A21D 8/08; A21D 13/10; A21B 3/139

(57) ABSTRACT

A system and method for preparing an edible bun are provided. The system comprises a first baking element and a second baking element. The first baking element defines a first interior cavity, a resting surface, and an opposing a receiving surface. The second baking element defines a second interior cavity, an outer surface, and an opposing inner surface. The method comprises inserting a first dough material into the first interior cavity in contact with the receiving surface; inserting the second baking element into the first baking element, such that the outer surface is in contact with the first dough material and a first bun portion is defined by the receiving surface and the outer surface; and inserting a second dough material into the second interior cavity and in contact with the inner surface, such that a second bun portion is defined by the inner surface of the second baking element.

### CROSS REFERENCES TO RELATED APPLICATION

This application claims the benefit of U.S. Provisional Application 63/178,135, filed Apr. 22, 2021, which is hereby incorporated by reference in its entirety.

### TECHNICAL FIELD

The invention relates to a system and method for making and preparing an edible bun, namely buns configured to receive edible contents therein.

### BACKGROUND

A variety of baking pans and methods of baking exist, which define an internal cavity therein. Such examples may include a traditional, single pan having a bottom and a plurality of side walls, such that the bottom and the plurality of side walls corporate to define a cavity therebetween, wherein the cavity is configured to receive a dough or other matter therein prior to the baking process. Existing examples may also include a single pan defining a plurality of cavities therein, wherein each cavity is configured to receive a dough or other matter therein prior to the baking process. In such an instance a single pan may produce several edible buns in the baking or preparation process.

### SUMMARY

A system and method for preparing an edible bun are provided. The system comprises a first baking element and a second baking element, wherein each of the first baking element and the second baking element have a floor portion and a plurality of side portions that collectively define an interior cavity therebetween. With respect to the first baking element, the floor portion and side portions collectively define a first baking element interior cavity, which defines a first width and a first length. The first baking element further defines a resting surface and an opposing receiving surface, with the receiving surface defining the first baking element interior cavity.

With respect to the second baking element, the floor portion and side portions collectively define a second baking element interior cavity, which defines a second width and a second length. The second width is shorter than the first width and the second length is shorter than the first length, such that the second baking element may fit within the first baking element interior cavity. The second baking element further defines an outer surface and an opposing inner surface, with the inner surface defining the second baking element interior cavity.

The method may include the steps of inserting a first dough material into the first baking element interior cavity, such that the first dough material is in contact with the receiving surface and inserting a second dough material into the second baking element interior cavity, such that the second dough material is in contact with the inner surface; positioning the second baking element within the first baking element interior cavity, wherein the outer surface is in contact with the first dough material. In this way, the receiving surface of the first baking element and the outer surface of the second baking element cooperate to define a first bun portion composed of the first dough material and the inner surface of the second baking element defines the second bun portion composed of the second dough material.

Upon combining the first baking element the second baking element, the first dough material, and the second dough material as detailed, the first baking element with the first dough material in contact with the receiving surface thereof, the second baking element in contact with the top surface of the first dough material, and the second dough material positioned within the second baking element interior cavity in contact with the inner surface thereof, may be collectively inserted into a heating implement, such as an oven, to concurrently bake the first dough material thereby producing the first bun portion and the second dough material thereby producing the second bun portion.

In this way, during the forming and baking process the second baking element concurrently forms the first bun portion and the second bun portion in that the outer surface of the second baking element defines the top surface of the first bun portion and the inner surface of the second baking element defines the bottom of the second bun portion. Moreover, in a stacked arrangement during the forming and baking process, a thickness of the second baking element defines the spacing between the first bun portion and the second bun portion. Such an orientation allows for the fully baked second bun portion to be nested within the fully-baked first portion.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic integrated perspective view of the system for making and preparing an edible bun.

FIG. 2 is a schematic non-integrated perspective view of the system for making and preparing an edible bun.

FIG. 3 is a schematic non-integrated perspective view of the system for making and preparing an edible bun, wherein the first baking element houses a first dough material and the second baking element houses a second dough material.

FIG. 4 is a schematic integrated cross-sectional view of the system for making and preparing an edible bun, wherein the first baking element houses a first dough material and the second baking element houses a second dough material.

FIG. 5 is a schematic exploded view of the system for making and preparing an edible bun, including the first baking element, the first bun portion, the second baking element, and the second bun portion.

FIGS. 6A and 6B are a series of schematic cross-sectional views detailed in step or flow chart form detailing the method making and preparing an edible bun.

FIG. 7 is a schematic view of a first embodiment of a completed edible bun produced via the system and method for making and preparing an edible bun disclosed herein.

FIG. 8 is a schematic view of a second embodiment of a completed edible bun produced via the system and method for making and preparing an edible bun disclosed herein.

FIG. 9 is a schematic view of a third embodiment of a completed edible bun produced via the system and method for making and preparing an edible bun disclosed herein.

### DETAILED DESCRIPTION

While the present disclosure may be described with respect to specific applications or industries, those skilled in the art will recognize the broader applicability of the disclosure. Those having ordinary skill in the art will recognize that terms such as “above,” “below,” “upward,” “downward,” etc., are used descriptively of the figures, and do not represent limitations on the scope of the disclosure, as defined by the appended claims. Any numerical designations, such as “first” or “second” are illustrative only and are not intended to limit the scope of the disclosure in any way.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

The terms “a,” “an,” “the,” “at least one,” and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The following discussion and accompanying figures disclose various edible buns 20, components of the system 10 for baking and preparing edible buns 20, and methods 100 relating to the preparation of an edible bun 20 via the disclosed system 10. Although the edible buns 20 herein are depicted as example hamburger, sandwich or other buns having a substantially round shape, in the associated figures, concepts associated with the configurations and methods may be applied to various types of edible buns 20 of varying shapes, sizes, e.g. an elongated hot dog bun, and configured to receive a variety of edible contents 18 within the internal cavity 60 thereof. Analogously, while the baking elements 12, 14 of the system 10 are depicted as example round or square baking elements 12, 14 in the associated figures, concepts associated with the configurations and methods 100 may be applied to various shapes, sizes, types, and composition of baking elements 12, 14, e.g., elongated buns or bread pockets.

Referring to the drawings, wherein like reference numerals refer to like components throughout the several views, a system 10 for preparing an edible bun 20 is provided, as well as a method 100 of making and preparing an edible bun 20 via the disclosed system 10. In a general sense, a system is provided for making and preparing an edible bun 20, wherein a first bun portion 24 may fully house a second bun portion 26 and any interior edible contents 18, such as meat, cheese, vegetables, condiments or the like within an internal cavity 60 formed in the first bun portion 12. Such an edible bun 20 is advantageous in holding in all contents of the sandwich or the like for an eating experience with less chance of mess or loss of edible contents 18, such as meat, cheese, vegetables, or condiments.

More particularly, such an edible bun 20 may be formed using the disclosed system 10 having a first baking element 12 and a second baking element 14, wherein a receiving surface 28 of the first baking element 12 and the outer surface 34 of the second baking element 14 are configured to collectively define the first bun portion 24, and wherein the inner surface 32 of the second baking element 14 is configured to define the second bun portion 26.

Such an edible bun 20 may be formed using the disclosed system 10 and via the disclosed method 100, which includes the steps of: inserting a first dough material into the first baking element 12 interior cavity 36, such that the first dough material is in contact with the receiving surface 28 and inserting a second dough material into the second baking element interior cavity 38, such that the second dough material is in contact with the inner surface 32; positioning the second baking element 14 within the first baking element interior cavity 36, wherein the outer surface 34 is in contact with the first dough material. In this way, the receiving surface 28 of the first baking element 12 and the outer surface 34 of the second baking element 12 cooperate to define a first bun portion 24 composed of the first dough material and the inner surface 32 of the second baking element 12 defines the second bun portion 26 composed of the second dough material.

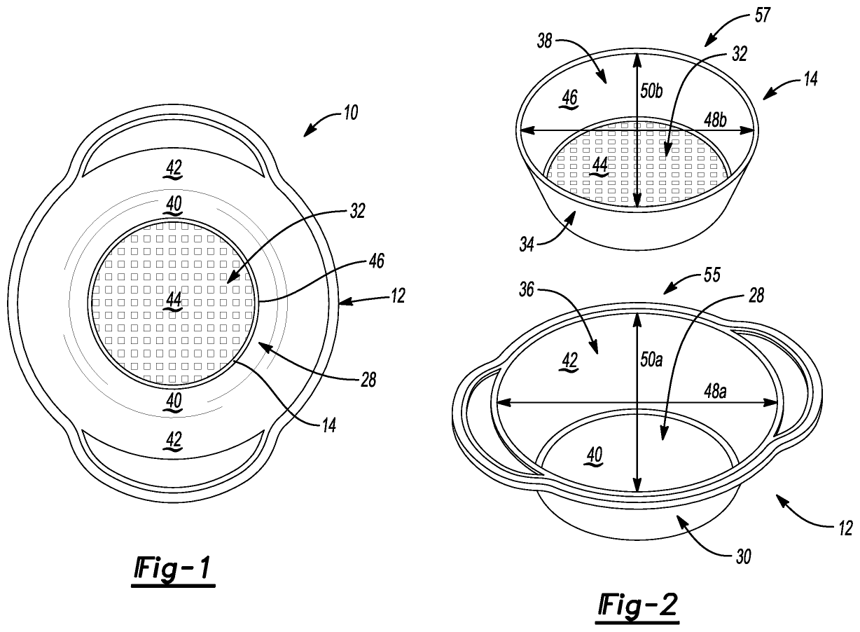

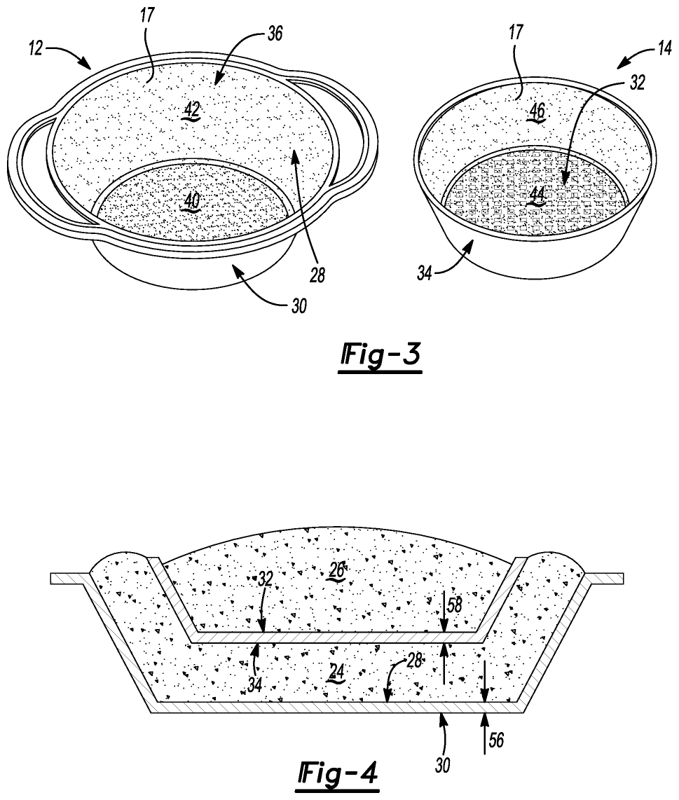

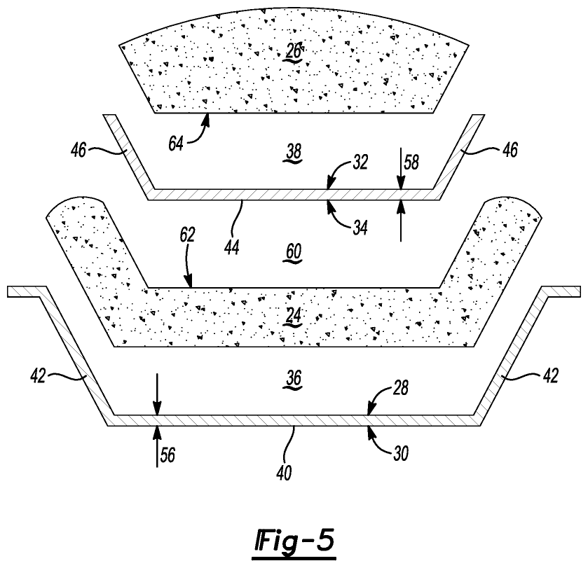

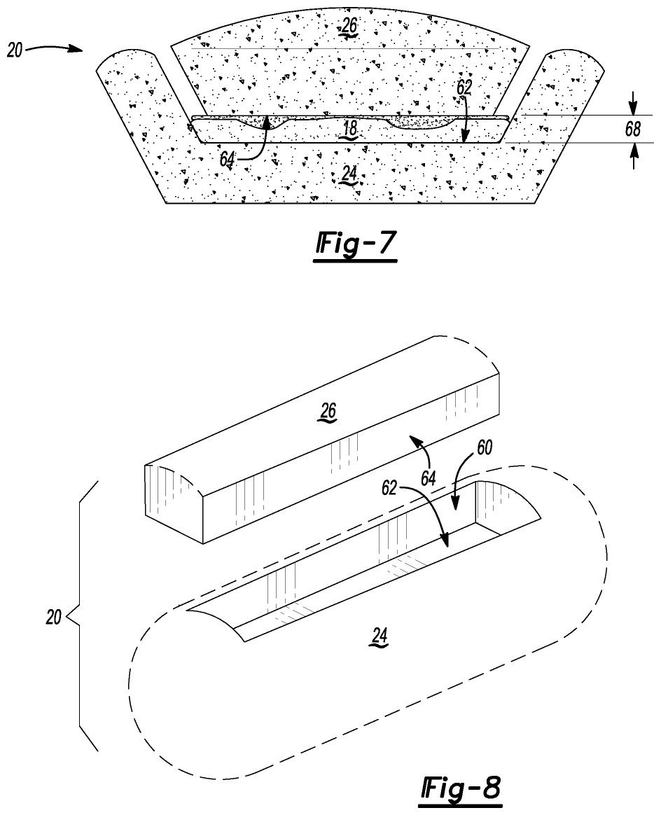

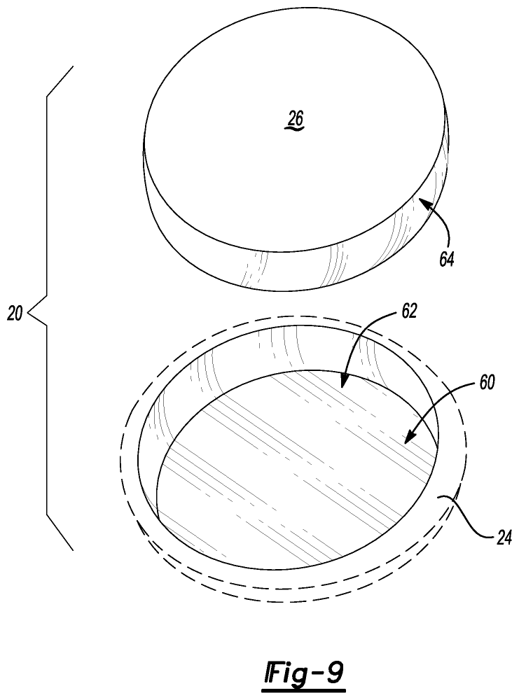

Referring to the drawings, wherein like reference numerals refer to like components throughout the several views, a system 10 and method 100 for making and preparing an edible bun 20 having a first bun portion 24 and a second bun portion 26 is provided. As shown in FIGS. 1-9, the system 10 comprising a plurality of baking elements 12, 14. By way of example, the baking elements 12, 14 may be baking pans, baking dishes, baking molds, or the like. In this way, the baking element may be formed of one of a metallic material, a glass-based material, a ceramic material, or a polymeric material. Each of the plurality of baking elements 12, 14 may be formed of the same material or of different materials.

Further, the plurality of baking elements 12, 14 may comprise at least a first baking element 12 and a second baking element 14. The first baking element 12 may comprise a floor portion 40 and a plurality of side portions 42. The floor portion 40 and the plurality of side portions 42 may collectively define a first baking element interior cavity 36 therebetween. The first baking element 12 may comprise at least one interior cavity 36, and the at least one interior cavity 36 may be a plurality of interior cavities 36. The first baking element 12 further forms a first shape 55, and wherein the first shape 55 may be one of a substantially circular shape, a polygonal shape, an elongated shape, elliptical shape, or an irregular shape.

More particularly, the first baking element 12 may further define a resting surface 30 and an opposing a receiving surface 28, such that each of the resting surface 30 and the receiving surface 28 are defined collectively by the floor portion 40 and a plurality of side portions 42 of the first baking element 12. The first baking element 12 may define a thickness 56 between the resting surface 30 and the receiving surface 28. Accordingly, the first baking element interior cavity 36 is defined by the receiving surface 28. More particularly, the first baking element interior cavity 36 has a first width 48a and a first length 50a.

The second baking element 14 may comprise a floor portion 44 and a plurality of side portions 46. The floor portion 44 and the plurality of side portions 46 may collectively define a second baking element interior cavity 38 therebetween. The second baking element 14 may comprise at least one interior cavity 38, and the at least one interior cavity 38 may be a plurality of interior cavities 38. The second baking element 14 may comprise a number of interior cavities 38 substantially equal to the number of interior cavities 36 of the first baking element 12. The second baking element 14 may be formed as a second shape 57 that is one of a substantially circular shape, elliptical shape, a polygonal shape, an elongated shape, or an irregular shape. The second shape 57 may be substantially similar to or different than the first shape 55.

The second baking element 14 may further define an outer surface 34 and an opposing inner surface 32, such that each of the outer surface 34 and the inner surface 32 are defined collectively by the floor portion 44 and a plurality of side portions 46 of the second baking element 14. The second baking element 14 may further define a thickness 58 between the outer surface 34 and the inner surface 32. Accordingly, the second baking element interior cavity 38 is defined by the inner surface 32. More particularly, the second baking element interior cavity 38 has a second width 48b and a second length 50b. The second width 48b is less than or shorter than the first width 48a, and the second length 50b is less than or shorter than the first length 50a, such that the second baking element 14 may be received by and nested within the interior cavity 36 of the first baking element 12.

In this way, during the forming and baking process the second baking element 14 concurrently forms the first bun portion 24 and the second bun portion 26 in that the outer surface 34 of the second baking element 14 defines the top surface 62 of the first bun portion 24 and the inner surface 32 of the second baking element 14 defines the bottom 64 of the second bun portion 26. Moreover, in a stacked arrangement during the forming and baking process, the thickness 58 of the second baking element 14 defines the spacing between the first bun portion 24 and the second bun portion 26. Such an orientation allows for the fully baked second bun portion 26 to be nested within the cavity 60 of the fully-baked first portion 24.

Accordingly, as shown in FIGS. 4-6B, a user may employ the system 10 detailed herein above in accordance with the following method 100, to make and prepare the edible bun 20, wherein a first bun portion 24 may fully house a second bun portion 26 and any interior edible contents 18 thereof, such as meat, cheese, condiments, or the like within an internal cavity 60 formed in the first bun portion 24. The method 100 comprises the following steps.

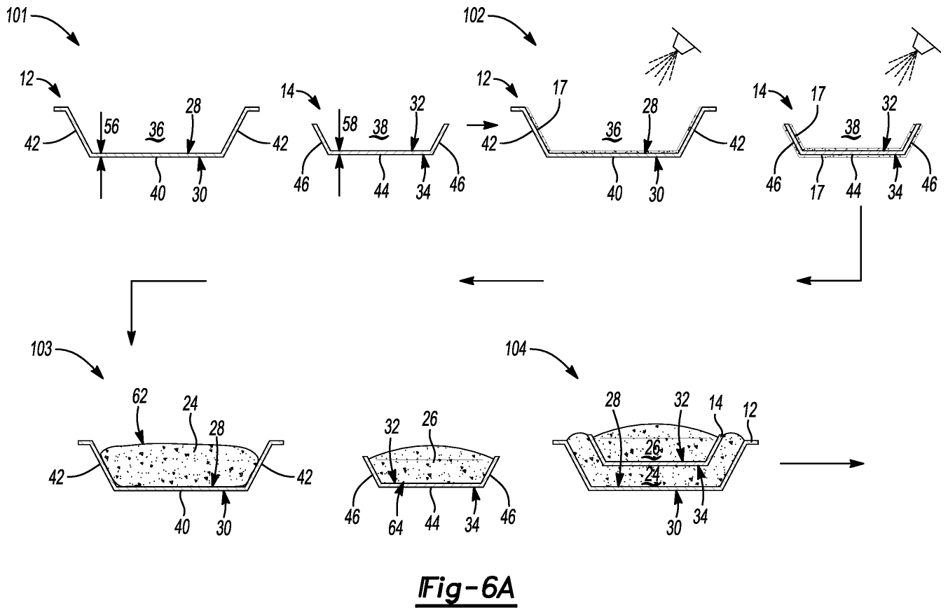

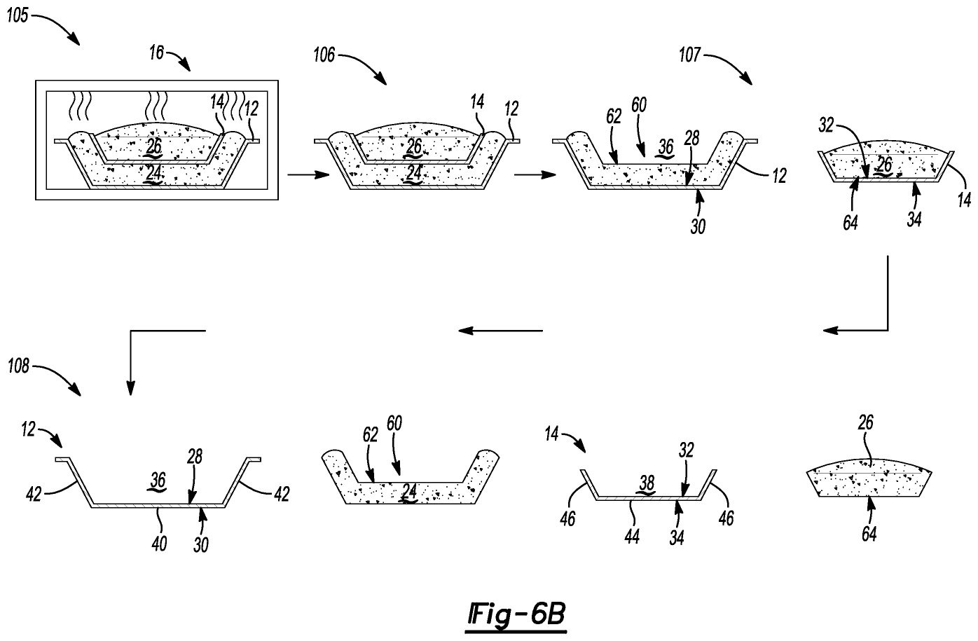

Referring specifically to FIG. 6A, at step 101, a first baking element 12 and a second baking element 14 are provided in accordance with the system 10 detailed herein above. More particularly, the first baking element 12 comprises a floor portion 40 and a plurality of side portions 42. The floor portion 40 and the plurality of side portions 42 may collectively define a first baking element interior cavity 36 therebetween, which is further defined by the receiving surface 28 of the first baking element 12. The first baking element 12 may define a thickness 56 between the resting surface 30 and the receiving surface 28. The first baking element 12 interior cavity 36 having a first width 48a and a first length 50a.

The second baking element 14 comprises a floor portion 44 and a plurality of side portions 46. The floor portion 44 and the plurality of side portions 46 may collectively define the second baking element interior cavity 38 therebetween, which is further defined by the inner surface 32 of the second baking element 14. The second baking element 14 may further define a thickness 58 between the outer surface 34 and the inner surface 32. The second baking element interior cavity 38 having a second width 48b and a second length 50b, with the second width 48b being less or shorter than the first width 48a and the second length 50b being less or shorter than the first length 50a.

Optionally, at step 102, the receiving surface 28 of the first baking element 12 and each of the outer surface 34 and the inner surface 32 of the second baking element are coated with a release agent 17. The release agent 17 may be a cooking spray or the like, operable to prevent the food product from sticking to the respective surface. Alternatively, the first baking element 12 and the second baking element 14 may be configured as non-stick baking elements that are either composed of or coated with a non-stick material such as Teflon®, such that the surfaces 28, 32, 34 do not require an additional coating with a release agent 17.

At step 103, the user may insert a first dough material into the first baking element 12 interior cavity 36, such that the first dough material is in contact with the receiving surface 28 and insert a second dough material into the second baking element interior cavity 38, such that the second dough material is in contact with the inner surface 32.

At step 104, the user may position the second baking element 14 within the first baking element interior cavity 36 thereby creating a stacked arrangement, wherein the outer surface 34 of the second baking element 14 is in contact with the first dough material. In this way, the receiving surface 28 of the first baking element 12 and the outer surface 34 of the second baking element 14 are configured to collectively define the first bun portion 24 composed of the first dough material and the inner surface 32 of the second baking element 14 is configured to define the second bun portion 26 composed of the second dough material.

Said another way, the second baking element 14 concurrently forms the first bun portion 24 and the second bun portion 26 in that the outer surface 34 of the second baking element 14 defines the top surface 62 of the first bun portion 24 and the inner surface 32 of the second baking element 14 defines the bottom 64 of the second bun portion 26. Moreover, in a stacked arrangement described in step 104, the thickness 58 of the second baking element 14 defines the spacing between the first bun portion 24 and the second bun portion 26. Such an orientation allows for the fully baked second bun portion 26 to be nested within the fully-baked first portion 12 cavity 60. In this way, the first bun portion 24 and the second bun portion 26 are baked simultaneously within the stacked arrangement of the system 10. During baking, the first dough portion and the second dough portion will rise and expand both upwardly and downwardly, such that the first dough portion forms the first bun portion 24 defined in shape by the receiving surface 28 of the first baking element 12 and the outer surface 34 of the second baking element 14 and the second dough portion forms the second bun portion 26 defined in shape by the inner surface 32 of the second baking element 14.

Referring to FIG. 6B, at step 105, the user may insert the stacked arrangement of the first baking element 12 with the first dough material, the second baking element 14 in contact with the first dough material, and the second dough material positioned with the second baking element interior cavity 38 into a heating implement 16. The heating or baking implement may be an oven or the like. The oven may be one of a conventional electric oven, a conventional gas oven, a convection oven, or the like.

At step 106, the user may remove the stacked arrangement of the first baking element 12 with the first dough material, the second baking element 14, and the second dough material positioned with the first interior cavity 36 from the heating implement 16.

At step 107, the user may remove the second baking element 14 with the second bun portion 26 within the second baking element interior cavity 38 thereof from the first baking element interior cavity 36. Upon the removal of the second baking element 14, the top surface 62 of the first bun portion 24 will remain in the shape of the outer surface 34 of the second baking element 14.

At step 108, the user may remove the first bun portion 24 from the first baking element interior cavity 36 and remove the second bun portion 26 from the second baking element interior cavity 38. In this way the bottom surface 64 of the second bun portion 26 remains in the shape of the inner surface 32 of the second baking element 14, and the bottom surface of the first bun portion 24 remains in the shape of the receiving surface 28 of the first baking element 12. The edible bun 20, comprising a first bun portion 24 and a second bun portion 26, is then ready for consumption, and as such interior edible contents 18, such as meat, cheese, condiments or the like may be positioned within the cavity 60 and topped or capped by placing the second bun portion 26 into the cavity 60 there above for a fully contained and dressed hamburger, hotdog, sandwich, or the like. The amount of edible contents 18 that may be positioned between the first bun portion 24 and the second bun portion 26 is a function of the size of the cavity 60, which is defined by the thickness 58 of the second baking element 14 during the baking process. Said another way, the height 68 of the cavity 60 is equivalent to the thickness 58 of the second baking element 14.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

1. A system for preparing an edible bun having a first bun portion, the system comprising:
a plurality of baking elements, each of the baking elements comprising a floor portion and a plurality of side portions, wherein the floor portion and the side portions collectively define an interior cavity therebetween, the plurality of baking elements including:
a first baking element defining a resting surface and an opposing receiving surface, such that each of the resting surface and the receiving surface are defined collectively by the floor portion and a plurality of side portions of the first baking element; and wherein the interior cavity is a first baking element interior cavity and the receiving surface defines the first baking element interior cavity;
a second baking element defining an outer surface and an opposing inner surface, such that each of the outer surface and the inner surface are defined collectively by the floor portion and a plurality of side portions of the second baking element; and wherein the interior cavity is a second baking element interior cavity and the inner surface defines the second baking element interior cavity; and
wherein the receiving surface of the first baking element and the outer surface of the second baking element are configured to collectively define the first bun portion.

2. The system of claim 1 wherein:
the interior cavity of the first baking element defines a first width and a first length;
the interior cavity of the second baking element defines second width and a second length; and
the second width is shorter than the first width, and the second length is shorter than the first length, such that the second baking element is configured to be received by and nested within the interior cavity of the first baking element.

3. The system of claim 2 wherein the first bun portion defines a cavity therein and the cavity has a height; and wherein the height of the cavity is substantially equal to a thickness of the second baking element.

4. The system of claim 3 wherein the edible bun further comprises a second portion, and wherein the inner surface of the second baking element is configured to define the second bun portion.

5. The system of claim 4 wherein:
the first bun portion has a top surface, and wherein the second bun portion has a bottom surface;
the top surface of the first bun portion being defined by the outer surface of the second baking element; and
the bottom surface of the second bun portion being defined by the inner surface of the second baking element.

6. The system of claim 5 wherein the first bun portion has a bottom surface, and wherein the bottom surface of the first bun portion defined by the receiving surface of the first baking element.

7. The system of claim 6 wherein the first baking element forms a first shape, and wherein the first shape is one of a substantially circular shape, an elliptical shape, a polygonal shape, or an irregular shape.

8. The system of claim 6 wherein the second baking element forms a second shape, and wherein the second shape is one of a substantially circular shape, an elliptical shape, a polygonal shape, or an irregular shape.

9. The system of claim 6 wherein the first baking element forms a first shape; and the second baking element forms a second shape; and wherein the first shape and the second shape are substantially similar.

10. The system of claim 6 wherein the first baking element is formed of one of a metallic material, a glass-based material, a ceramic material, or a polymeric material.

11. The system of claim 6 wherein the second baking element is formed of one of a metallic material, a glass-based material, a ceramic material, or a polymeric material.

12. The system of claim 6 wherein the first baking element and the second baking element are formed of the same material.

13. The system of claim 6 wherein the first baking element and the second baking element are formed of different materials.

14. A method of preparing an edible bun, the method comprising:
providing a first baking element and a second baking element, wherein:
the first baking element comprises a floor portion and a plurality of side portions, wherein:
the floor portion and the plurality of side portions collectively define a first baking element interior cavity therebetween, such that the first baking element interior cavity defines a first width and a first length; and
the first baking element defines a resting surface and an opposing receiving surface, the receiving surface further defining the first baking element interior cavity;
the second baking element comprising a floor portion and a plurality of side portions, wherein:
the floor portion and the plurality of side portions collectively define a second baking element interior cavity therebetween, such that the second baking element interior cavity defines a second width and a second length, the second width being less than the first width and the second length being less than the first length; and
the second baking element defines an outer surface and an opposing inner surface, the inner surface further defining the second baking element interior cavity; and
inserting a first dough material into the first baking element interior cavity, such that the first dough material is in contact with the receiving surface and positioning the second baking element within the first baking element interior cavity, wherein the outer surface of the second baking element is in contact with the first dough material, such that a first bun portion composed of the first dough material is defined by the receiving surface of the first baking element and the outer surface of the second baking element.

15. The method of claim 14 further comprising inserting a second dough material into the second baking element interior cavity, wherein the second dough material is in contact with the inner surface, such that a second bun portion composed of the second dough material is defined by the inner surface of the second baking element.

16. The method of claim 15 further comprising coating the receiving surface of the first baking element and each of the outer surface and the inner surface of the second baking element with a release agent.

17. The method of claim 15 further comprising inserting the first baking element with the first dough material, the second baking element positioned in contact with the first dough material, into a heating implement.

18. The method of claim 17 further comprising removing the first baking element with the first dough material, the second baking element from the heating implement.

19. The method of claim 18 further comprising removing the second baking element from the first baking element interior cavity.

20. The method of claim 19 further comprising:
removing the first bun portion from the first baking element interior cavity, wherein a bottom surface of the first bun portion is defined by the receiving surface of the first baking element and a top surface of the first bun portion is defined by the outer surface of the second baking element.

21. The method of claim 15 further comprising inserting the first baking element with the first dough material, the second baking element positioned in contact with the first dough material, and the second dough material positioned within the second baking element interior cavity into a heating implement.

22. The method of claim 21 further comprising removing the first baking element with the first dough material, the second baking element, and the second dough material positioned within the first interior cavity thereof from the heating implement.

23. The method of claim 22 further comprising removing the second baking element with the second bun portion within the second baking element interior cavity thereof from the first baking element interior cavity.

24. The method of claim 23 further comprising:
removing the first bun portion from the first baking element interior cavity, wherein a bottom surface of the first bun portion is defined by the receiving surface of the first baking element and a top surface of the first bun portion is defined by the outer surface of the second baking element; and
removing the second bun portion from the second baking element interior cavity; wherein a bottom surface of the second bun portion is defined by the inner surface of the second baking element.

25. The method of claim 24 wherein the first baking element forms a first shape, and wherein the first shape is one of a substantially circular shape, an elliptical shape, a polygonal shape, or an irregular shape.

26. The method of claim 24 wherein the second baking element forms a second shape, and wherein the second shape is one of a substantially circular shape, an elliptical shape, a polygonal shape, or an irregular shape.

27. The method of claim 24 wherein the first baking element forms a first shape; and the second baking element forms a second shape; and wherein the first shape and the second shape are substantially similar.

28. The method of claim 24 wherein the first baking element is formed of one of a metallic material, a glass-based material, a ceramic material, or a polymeric material.

29. The method of claim 24 wherein the second baking element is formed of one of a metallic material, a glass-based material, a ceramic material, or a polymeric material.

30. The method of claim 24 wherein the first baking element and the second baking element are formed of the same material.

31. The method of claim 24 wherein the first baking element and the second baking element are formed of the different materials.
